(19) United States
(12) Patent Application Publication
(10) Pub. No.: US 2022/0307569 A1
(43) Pub. Date: Sep. 29, 2022

(54) COMPOSITE STRUCTURES WITH DAMPING CHARACTERISTICS

(71) Applicant: FUTURE COMP. LLC, Gunnison, UT (US)

(72) Inventors: Joseph Stanish, Gunnison, UT (US); Kelly John Kirby, Gunnison, UT (US)

(21) Appl. No.: 17/656,835

(22) Filed: Mar. 28, 2022

Related U.S. Application Data
(60) Provisional application No. 63/300,582, filed on Jan. 18, 2022.
(60) Provisional application No. 63/166,854, filed on Mar. 26, 2021.

(51) Int. Cl. F16F 15/02; F16L 55/02

(52) U.S. Cl. CPC F16F 15/02; F16L 55/02; F16F 2238/04; F16F 2224/0241; F16F 2230/0029; F16F 2234/00

(57) ABSTRACT

A composite structure includes a thermoplastic material and axial fibers and radial fibers arranged within the thermoplastic material. The thermoplastic material can define a substructure of the composite structure. The fibers can be continuous and/or discontinuous fibers. The substructure can be a first substructure and the composite structure can further include a second substructure. Opposing ends of the first substructure and the second substructure are bonded with one another to form a tubular structure. The composite structure can exhibit enhanced damping characteristics such as having a damping coefficient greater than 0.5 lbf s/in. In some cases, this can limit vibrations of the tubular structure to less than 5.0 m/s2.

### CROSS-REFERENCE TO RELATED APPLICATION

This application claims the benefit of priority to U.S. Provisional Application No. 63/300,582, entitled “COMPOSITE STRUCTURES WITH DAMPENING CHARACTERISTICS”, FILED 18 Jan. 2022, which claims the benefit of priority to U.S. Provisional Application No. 63/166,854 entitled “COMPOSITE STRUCTURES WITH DAMPING CHARACTERISTICS”, filed Mar. 26, 2021, which is hereby incorporated by reference in its entirety.

### FIELD

The described embodiments relate generally to fiber reinforced thermoplastic structures, and more particularly, to composite tubular structures formed from fiber reinforced thermoplastic materials.

### BACKGROUND

Vibrations in mechanical systems can often be undesirable. For example, a portion of a structural component can oscillate in response to a load, displacement, velocity or other input. Such oscillations can waste system energy and create noise. Overtime, the oscillations can weaken or fatigue the structural component, and contribute to system failure or breakdown. However, structural components are often exposed to forces that induce vibrations, such as a handlebar of a bicycle exposed to forces of a rider's grip, or a pipe coupling exposed to fluid hammer in a line. As such, the need continues for systems and techniques to facilitate vibration reduction in mechanical systems.

### SUMMARY

Examples of the present invention are directed to a composite structure with damping characteristics.

In one example, a composite structure is disclosed. The composite structure can include a thermoplastic material. The composite structure can further include axial fibers and radial fibers arranged within the thermoplastic material. The thermoplastic material defines a substructure of the composite structure.

In another example, the substructure can be a first substructure. The composite structure can further include a second substructure. Opposing ends of the first substructure and the second substructure can be bonded with one another to form a tubular structure. The tubular structure can have a damping coefficient greater than 0.5 lbf s/in. Vibrations of the tubular structure can be limited to less than 5.0 m/s2.

In another example, the composite structure further includes a reinforcement substructure formed over one or both of the first substructure or the second substructure. The reinforcement substructure can include complete or partial hoop windings of a reinforcement fiber. In some cases, a subset of one or both of the axial fibers or the radial fibers can be discontinuous.

In another example, a composite structure is disclosed. The composite structure includes a thermoplastic material. The composite structure further includes an arrangement of continuous and discontinuous fibers within the thermoplastic material. The thermoplastic material defines a substructure of the composite structure with the arrangement of continuous and discontinuous fibers extending substantially in a radial direction of the substructure.

In another example, the substructure can be a first substructure. The composite structure can further include a second substructure. Opposing ends of the first substructure and the second substructure can be bonded with one another to form a tubular structure. The tubular structure can have a damping coefficient greater than 0.5 lbf s/in. Vibrations of the tubular structure are less than 5.0 m/s2.

In another example, the composite structure includes a reinforcement substructure formed over one or both of the first substructure or the second substructure. The reinforcement substructure can include complete or partial hoop windings of a reinforcement fiber. The arrangement of continuous and discontinuous fibers can further include fibers extending substantially in an axial direction of the substructure.

In another example, a composite structure is disclosed. The composite structure includes a first substructure formed from a reinforced thermoplastic material. The composite structure further includes a second substructure formed from a reinforced thermoplastic material. Opposing ends of the first substructure and the second substructure are overlapped with one another to define a tubular structure. The overlap is greater than 0.030″ in either an axial or radial direction.

In another example, the overlap defines scarf joint.

In another example, the composite structure further includes a third substructure formed from a reinforced thermoplastic material. The composite structure further includes a fourth substructure formed from a reinforced thermoplastic material. The tubular structure can be an inner tubular structure. Further, opposing ends of the third substructure and the fourth substructure can be overlapped with one another to define an outer tubular structure over the inner tubular structure.

In another example, the tubular structure has a damping coefficient greater than 0.5 lbf s/in. Vibrations of the tubular structure are less than 5.0 m/s2. In some cases, the composite structure can further include a reinforcement substructure formed over one or both of the first substructure or the second substructure. The reinforcement substructure can include complete or partial hoop windings of a reinforcement fiber.

In another example, a composite structure is disclosed. The composite structure includes a first substructure formed from a reinforced thermoplastic material. The composite structure further includes a second substructure formed from a reinforced thermoplastic material. Opposing ends of the first substructure and the second substructure are overlapped and bonded with one another through time, heat, and pressure to define a tubular structure.

In another example, the reinforced thermoplastic material includes a thermoplastic material. The reinforced thermoplastic material further includes axial fibers and radial fibers arranged within the thermoplastic material. In some cases, a subset of one or both of the axial fibers or the radial fibers are discontinuous.

In another example, the tubular structure can have a damping coefficient greater than 0.5 lbf s/in. Vibrations of the tubular structure are less than 5.0 m/s2. The composite structure can further include a reinforcement substructure formed over one or both of the first substructure or the second substructure. The reinforcement substructure can include complete or partial hoop windings of a reinforcement fiber.

In another example, a composite structure is disclosed. The composite structure has a thermoplastic material defining a tubular structure. The composite structure has an arrangement of fibers within the thermoplastic material. The tubular structure has a damping coefficient greater than 0.5 lbf s/in. The tubular structure can define a handlebar of a bicycle, a fitting of a pipe coupling, or a fitting of a structural coupling, among other implementations.

In another example, a composite structure is disclosed. The composite structure includes a thermoplastic material defining a tubular structure. The composite structure further includes an arrangement of fibers within the thermoplastic material. Vibrations of the tubular structure are less than 5.0 m/s2. The tubular structure can define a handlebar of a bicycle, a fitting of a pipe coupling, or a fitting of a structural coupling, among other implementations.

In another example, a composite structure is disclosed. The composite structure includes a first substructure formed from a reinforced thermoplastic material. The composite structure further includes a second substructure formed from a reinforced thermoplastic material. The composite structure further includes a reinforcement substructure formed with fibers extending substantially transverse along one or both of the first substructure or the second substructure. Opposing ends of the first substructure and the second substructure are overlapped with one another to define a tubular structure.

In another example, a method of forming a composite structure is disclosed. The method includes forming a first substructure from a reinforced thermoplastic material. The method further includes forming a second substructure from a reinforced thermoplastic material. The method further includes overlapping opposing ends of the first substructure with opposing ends of the second substructure and defining a cavity therebetween. The method further include bonding to the first substructure and second substructure to one another and defining a segment of a tubular structure.

In another example, a method of reinforcing a composite structure is disclosed. The method includes forming a tubular composite structure having a thermoplastic material and fibers disposed with the thermoplastic material. The method further includes forming a reinforcing layer over a portion of the composite structure, the reinforcing layer having fibers extending along a radial direction of the tubular composite structure.

In another example, a composite structure is disclosed. The composite structure includes a first substructure formed from a reinforced thermoplastic material and having reinforcement fibers arranged in a first pattern. The composite structure further includes a second substructure formed from a reinforced thermoplastic material and having reinforcement fibers arranged in a second pattern. The first substructure and the second substructure are molded to one another to define continuous section of the composite structure having the reinforcement fibers in both the first pattern and the second pattern.

In another example, the first pattern may include an arrangement of axial fibers disposed within the thermoplastic material of the first substrate. Further, the second pattern may include an arrangement of axial fibers disposed within the thermoplastic material of the second substrate. Further, the axial fibers of the second pattern may be disposed off-axis to the axial fibers of the first pattern in the continuous section of the composite structure.

In another example, the first pattern includes an arrangement of radial fibers disposed within the thermoplastic material of the first substrate. The second pattern may include an arrangement of radial fibers disposed within the thermoplastic material of the second substructure. The radial fibers of the second pattern may be disposed off-axis to the radial fibers of the first pattern in the continuous section of the composite structure.

In another example, the first pattern may include an arrangement of axial fibers disposed within the thermoplastic material of the first substrate. The second pattern may include an arrangement radial fibers disposed within the thermoplastic material of the second substrate.

In another example, the reinforcement fibers of the first substructure and the reinforcement fibers of the second substructure may be discontinuous with one another in the continuous section of the composite material.

In another example, the composite structure has a damping coefficient great than 0.5 lbf s/in. Additionally or alternatively, vibrations of the composite structure are less than 5.0 m/s2.

In another example, at least one of the first substructure of the second substructure include reinforcement fibers in both the radial and the axial direction.

In another example, a method of forming a composite structure. The method includes providing a substructure formed from a reinforced thermoplastic material. The reinforced thermoplastic material having reinforcement fibers arranged in a defined pattern. The method further includes breaking the substructure into a plurality of pieces of the thermoplastic material. The method further includes arranging the plurality of pieces of the thermoplastic material in a mold. The method further includes bonding the plurality of pieces to one another and defining a continuous section of the composite structure including segments of the reinforcement fibers in the defined pattern arranged off-axis from one another.

In another example, the defined pattern includes an arrangement of one or both of axial fibers or radial fibers. One or both of the axil fiber or radial fibers are discontinuous with a respective piece of the plurality of pieces.

In another example, the substructure may be a first substructure and the defined pattern is a first defined pattern. In this regard, the method may further include providing a second substructure form from a reinforce thermoplastic material. The reinforced thermoplastic material may have reinforcement fibers arrange in a second defined pattern. The method may further include breaking the second substructure into a plurality of pieces of the thermoplastic material. The method may further include arranging select pieces of the first substructure and the second substructure in the mold. The method may further include bonding the select pieces of the first substructure and the second substructure to one another and defining the continuous section of the composite structure including the reinforcement fibers arranged in the first pattern and the second pattern.

In another example, the first pattern includes an arrangement of axial fibers. The second pattern includes an arrangement of the radial fibers.

In another example, the fibers of the first pattern and the second pattern are discontinuous with one another in the continuous section of the composite structure.

In another example, each piece of the plurality of pieces has the reinforcement fibers in the defined pattern.

In another example, the composite structure has a damping coefficient great than 0.5 lbf s/in. Additionally or alternatively, vibrations of the composite structure are less than 5.0 m/s2.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts an example reinforced thermoplastic substructure;

FIG. 1B depicts another example reinforced thermoplastic substructure;

FIG. 1C depicts another example reinforced thermoplastic substructure;

FIG. 1D depicts another example reinforced thermoplastic substructure;

FIG. 1E depicts another example reinforced thermoplastic substructure;

FIG. 1F depicts another example reinforced thermoplastic substructure;

FIG. 2 depicts another example reinforced thermoplastic substructure having a reinforcement structure;

FIGS. 3A and 3B depict an example composite structure;

FIGS. 4A and 4B depict another example composite structure;

FIG. 5A depicts a chart showing example angular velocity curves for a composite structure of the present disclosure as compared to conventional thermoset structures;

FIG. 5B depicts a chart showing example angular velocity distributions for a composite structure of the present disclosure as compared to conventional thermoset structures;

FIG. 6 depicts another example composite structure formed as handlebar for a bicycle;

FIG. 7 depicts another example composite structure formed as a handlebar for a bicycle;

FIG. 8 depicts a pipe coupling including a composite structure of the present disclosure;

FIG. 9 depicts a structural element coupling including a composite structure of the present disclosure;

FIG. 10 depicts a flow diagram for forming a composite structure;

FIG. 11 depicts a flow diagram for reinforcing a composite structure;

FIG. 12A depicts separated pieces of the example reinforced thermoplastic substructure of FIG. 1A;

FIG. 12B depicts separated pieces of the example reinforced thermoplastic substructure of FIG. 1B;

FIG. 13 depicts separated pieces of reinforced thermoplastic substructures arranged relative to a mold;

FIG. 14 depicts an example reinforced thermoplastic substructure formed from the separated pieces of FIG. 13; and

FIG. 15 depicts a flow diagram forming reinforced thermoplastic substructure formed from recycled pieces.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to composite structures configured to exhibit enhanced damping characteristics. For example, the composite structures disclosed herein can be configured to exhibit a damping coefficient of greater than about 0.5 lbf s/in. Additionally or alternatively, the composite structures disclosed herein can be configured to limit vibrations to a value of less than about 5.0 m/s2. In this regard, the composite structures can satisfy the ISO 5349-1:2001 standard for safe levels of damping. The composite structures can also satisfy other ISO standards associated with mechanical damping, including the ISO 4210-5 standard for minimum safe structural levels of damping in a handlebar of a bicycle.

The composite structures of the present disclosure having the enhanced damping characteristics can include a reinforced thermoplastic material. The reinforced thermoplastic material can be configured to enhance the damping characteristics of the composite structure while forming the structures as lighter weight and less stiff than conventional designs. For example, the reinforced thermoplastic material can include a thermoplastic material, and fibers arranged with the thermoplastic material in a variety of orientations, lengths, and material types. Without limitation, the thermoplastic material can generally be defined by any material or collection of materials that is generally softened through the application of heat, and conversely hardened when cooled, including certain resins, polymers, synthetics, nylons, and/or other materials and blends. The thermoplastic material can be impregnated with the fibers to establish the fibers as reinforcement fibers in the thermoplastic material. Example fibers include, without limitation, certain carbon fibers, glass fibers, Kevlar fibers, and/or basalt fibers, among other options contemplated herein.

The composite structures of the present disclosure can have a reinforced thermoplastic material with fibers in a defined orientation to induce the damping characteristics described herein. For example, the composite structure can include a substructure formed the reinforced thermoplastic material with reinforcement fibers arranged extending along a radial direction of the substructure. The composite structure can further include a substructure formed the reinforced thermoplastic material with reinforcement fibers arranged extending along an axial direction of the substructure. In some cases, the substructure can include reinforcement fibers extending along both the axial direction and the radial direction of the substructure. The reinforcement fibers can also be discontinuous in one or both of the radial or axial directions. In this regard, the substructure can be formed having a pattern of long fibers and short fibers in either the radial or axial direction.

The fibers of the substructure can overlap with one another. For example, reinforced thermoplastic materials can be manufactured in a variety of manners with the fiber impregnated into the thermoplastic material. In some cases, a complete or partial winding process can be used to set a pattern or weave for the fibers. A spread technique can be used to establish the fibers in a thermoplastic material to spread and arrange the fibers in an elongated fashion. In other cases, other techniques can be used. In this regard, the reinforcement fibers can be directed and set in the thermoplastic material in a desired orientation, e.g., a radial orientation, an axial orientation, an off-axis orientation, and so on, including combinations thereof. The reinforcement fibers can also be set in the thermoplastic material in a desired pattern or consistency, e.g., long fibers, short fibers and/or to define an overlap or weave, as appropriate. The reinforced thermoplastic material can be formed as a sheet, roll, tape, panel and so forth. The reinforced thermoplastic material can be subsequently manipulated to form a desired shape of the composite structure.

The composite structures of the present disclosure may be recycled and formed into a new composite structure, using the techniques described herein. For example, an initial composite structure may include a thermoplastic material and a combination of axial and/or radial fibers arranged within the thermoplastic material in a defined pattern. The initial composite structure may be processed in order to form a recycled composite structure. For example, the initial composite structure may be broken into a plurality of separate pieces. In some cases, each piece of the plurality of pieces may include the thermoplastic material and reinforcement fibers in a defined pattern. For example, each piece of the plurality of pieces may have reinforcement fibers in the axial pattern, radial pattern, or combination of thereof, based on the configuration of the initial composite structure. The plurality of pieces of may subsequently be arranged in a mold in order to form a new, recycled composite structure or component. In some cases, the plurality of pieces may be intermixed with other pieces of the reinforced thermoplastic material, such as pieces from other composite structures optionally having a different arrangement of fibers. The various pieces may be bonded to one another in the mold in order to define a continuous section of the recycled composite structure.

In some cases, the recycled composite structure may include segments of the reinforcement fibers that are discontinuous with one another. For example, the recycled composite structure may be defined by a patchwork of pieces of the initial composite structures. Each piece may include reinforcement fibers in a defined pattern, such as in a first radial pattern, and a second axial pattern, or combination of each. The pieces may be substantially seamlessly bonded and formed with one another with respect to the thermoplastic material within which the reinforcement fibers are disposed. The reinforcement fibers of each adjacent piece may be discontinuous with one another in the continuous section of the recycled composite structure. This may allow for the construction of the recycled composite structures with reinforcement fibers in various orientations and in a manner that is tuned to increase material strength, and optimize damping the vibrations characteristics. In some cases, the arrangement of the fibers and materials may be tuned in order to increase a stiffness of the resulting recycled composite structure. Additionally, the techniques described herein may allow for the creation of new shapes and structures that are different than the shapes and structures of the initial composite structure. As one example, and as described herein, the initial composite structures may be a first shape, and the recycled composite structure may be a second shape, in shapes that are more complex than the first shape.

Further, the composite structure of the present disclosure can include multiple substructures that cooperate to define a substantially tubular structure. The substantially tubular structure can exhibit enhanced and optimized damping characteristics based in part on the arrangement of fibers in the reinforced thermoplastic material of the composite structure. As one example, the composite structure includes a first substructure and a second substructure, such as any of the substructures described above. Opposing ends of the first and second substructures can be associated with one another, such as being overlapped, to define the substantially tubular structure. For example, each of the first and second substructures can be clamshell-type or C-type shapes having a concave region. When the first and second substructures are associated with one another with respective concave regions facing and joined, the first and second substructures can define the tubular structure. The first and second substructures can be overlapped at opposed ends to define a lap joint, a scarf joint, and so on. The overlap can be at least about 0.030 inches. Heat and pressure can be applied to the first and second substructure to bond the substructures to one another and form the composite structure. The heat and pressure can bond the first and second substructures in a manner to form a substantially integral structure, in which the composite structure is generally a one-piece, continuous and/or seamless structure after formation.

In some cases, a reinforcement structure can be associated with the first and/or second substructures during the formation of the composite structure. For example, reinforcement fibers can be selectively associated with the first and/or second substructures to reinforce the composite structure at target areas, such as an area anticipated to receive an applied load during use. To facilitate the foregoing, the reinforcement fibers of the reinforcement structure can be hoop-wound over selected portions of the first and/or second substructures, individually. The hoop-wound fibers can extend substantially transverse to at least one fiber direction of the respective substructure. The first and second substructures can then be bonded with one another, as described above, to form the substantially tubular structure. By completing the reinforcement on each substructure individually, increased reinforcement strength is provided through and along the joints of the first and second substructure. Additionally or alternatively, the reinforcement fibers can be hoop-wound about the first and second substructures together, such as about the substantially tubular structure defined by the first and second substructures.

In addition to the first and second substructures, in other examples, the composite structure can further include a third substructure and a fourth substructure. The third substructure and the fourth substructure can be substantially analogous to the first and second substructures and be formed from a thermoplastic material and each define a clamshell-type or C-type shape. When the composite structure includes four substructures, the tubular structure of the joined first and second substructures can be an inner tubular structure. Opposing ends of the third substructure and the fourth substructure can be joined, such as being overlapped, with one another to define an outer tubular structure that fits over the inner tubular structure. The overlap of the opposing ends of the third and fourth substructures can be arranged at substantially 90° from the overlap of the opposing ends of the first and second substructures. Heat and pressure can be applied to the stack up of the first, second, third, and fourth substructures to bond the substructures to one another and form the composite structure. One or more reinforcement structures can be applied to the four substructure example, as described above. In other examples, additional substructures can be used, including substructures that define other shapes, such as non-tubular shapes, and so on.

The composite structures of the present disclosure can be used to form a handlebar structure for bicycle. For example, the tubular structures described herein can be formed as a substantially elongated structured having end portions that are configured to define handlebars and a middle portion that is configured to facilitate attachment of the handlebar structure to a stem, headset, tube, frame or other appropriate structure of a bicycle. The composite structure can be lighter, less, stiff and generally have a higher damping coefficient than conventional handlebar structures. For example, the reinforcement fibers of the composite structure can be arranged to define a damping coefficient of about greater than 0.5 lbf s/in. The handlebar structure can also satisfy the ISO 4210-5 for minimum safe structural levels of a handlebar. One or more of the reinforcement structures descried above can be applied to mount points, the ends of the bars, or other portions to add increased strength.

It will be appreciated that the handlebar structure describe above is one example implementation of a composite structure having enhanced and optimized damping characteristics. Broadly, the composite structures described herein can be used in substantially any mechanical system in which vibration reduction is desired. As one example, the composite structure of the present disclosure can be used as a fitting between sections of pipe. Oil and natural gas pipelines, for example, can experience fluid hammer and other conditions that contribute to unwanted vibration in the pipeline, especially at junctions in the pipeline. The composite structure can be used as a sleeve or coupling or other component of a pipe coupling to mitigate the propagation of vibration throughout the pipeline. As another example, the composite structure can be used as a component of a structural coupling, such as coupling for rebar or other building elements which can exhibit vibrations.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

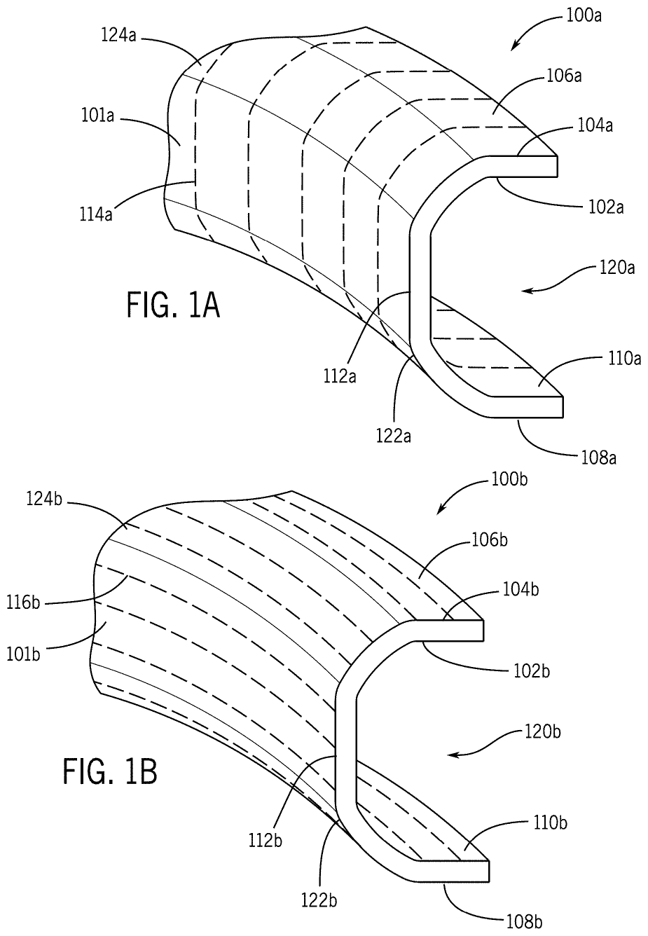

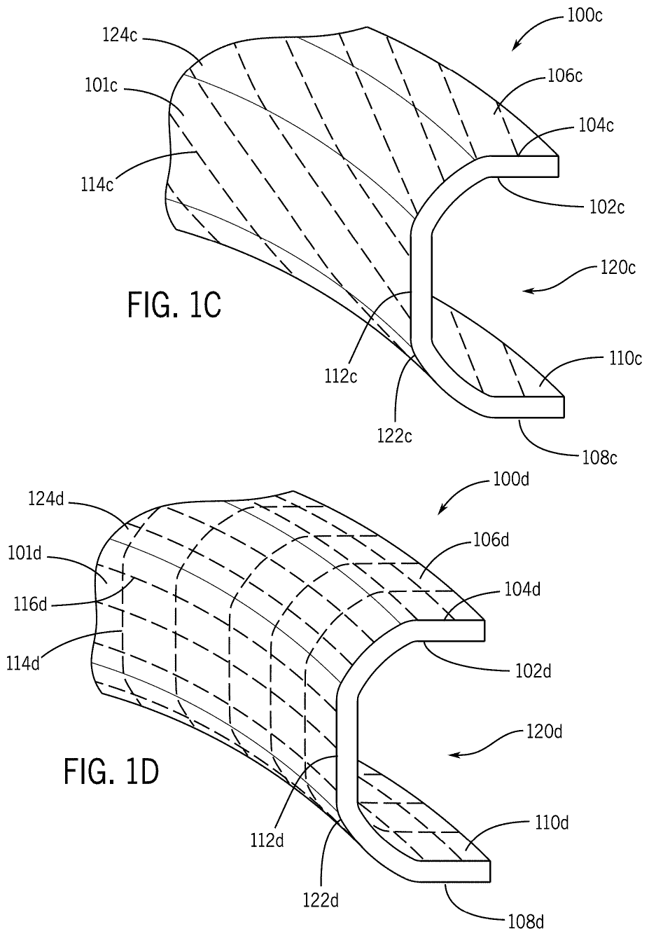

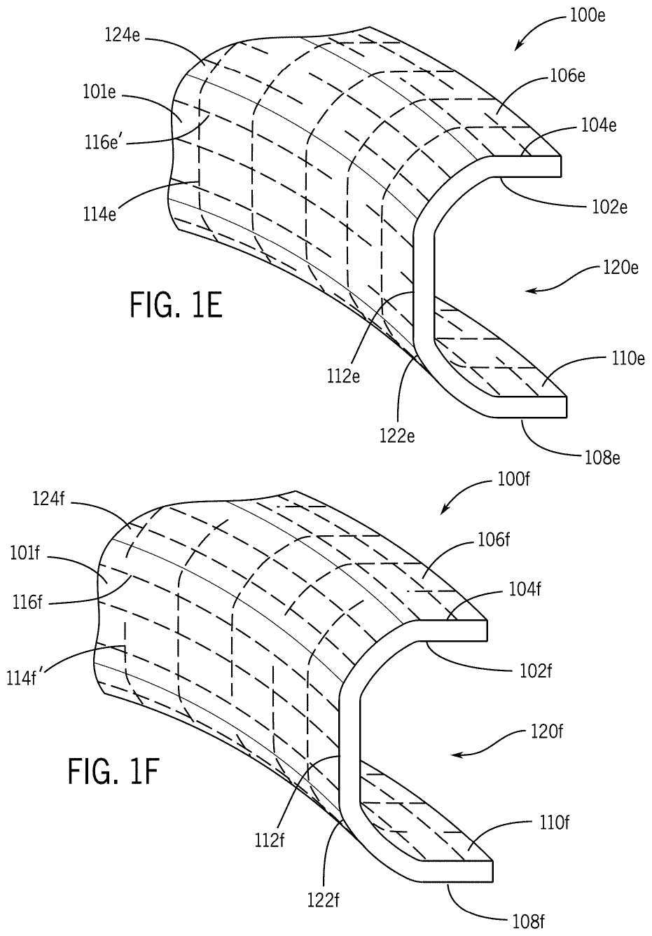

FIGS. 1A-1F depict various example substructures of a composite structure, such as any of the substructures discussed above and described further in greater detail below. With reference to FIG. 1A, a substructure 100a is shown. The substructure 100a is shown in FIG. 1A defining a clamshell-type shape 102a. For example, the substructure 100a can include a first end portion 104a, a second end portion 108a, and a middle portion 112a that cooperate to define the clamshell-type shape 102a or C-type shape. As shown in FIG. 1A, the first end portion 104a can extend curved from the middle portion 112a, and the second end portion 108a can extend curved from an opposing end of the middle portion 112a. The first and second end portions 104a, 108a can define a concave region 120a with respect to the middle portion 112a. The substructure 100a can generally be an elongated structure extending axially from a first longitudinal end 122a to a second longitudinal end 124a. The concave region 120a can therefore be defined as a channel or groove extending along an axial direction of the substructure 100a, with the first end portion 104a, middle portion 112a, and the second end portion 108a positioned generally radial about the axial direction.

As further shown in FIG. 1A, the first end portion 104a can define a first overlap region 106a. The second end portion 108a can define a second overlap region 110a. The first and second overlap region 106a, 110a can facilitate joining of the substructure 100a to another substructure, such as for joining the substructure 100a to another substructure to form a composite structure. For example, one or both of the overlap regions 106a, 110a can define opposing ends of the clamshell-type shape 102a. The overlap regions 106a, 110a can be configured to fit over and overlap opposing ends of another substructure. In other cases, one or both of the overlap regions 106a, 110a can be configured to be received by or slid at least partially under and overlap opposing ends of another substructure. The overlap regions 106a, 110a can therefore facilitate a mechanical connection, including an interference or friction fit with another substructure. Heat and pressure can be subsequently applied to the mechanical connection to form the composite structure. In some cases, notches, grooves, indents, including complimentary features, can be formed in one or both of the overlap regions 106a, 110a to facilitate the mechanical connection, such as can be the case with a scarf joint.

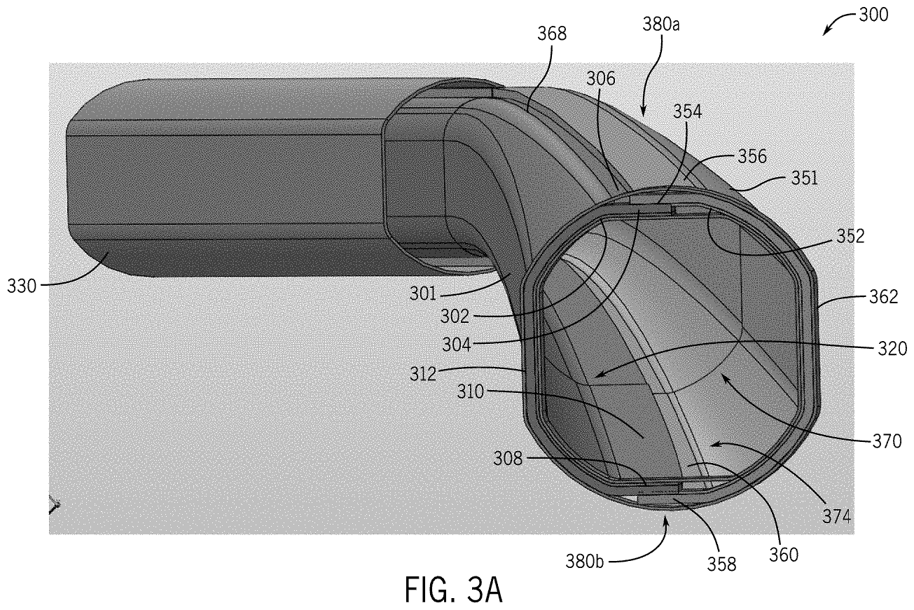

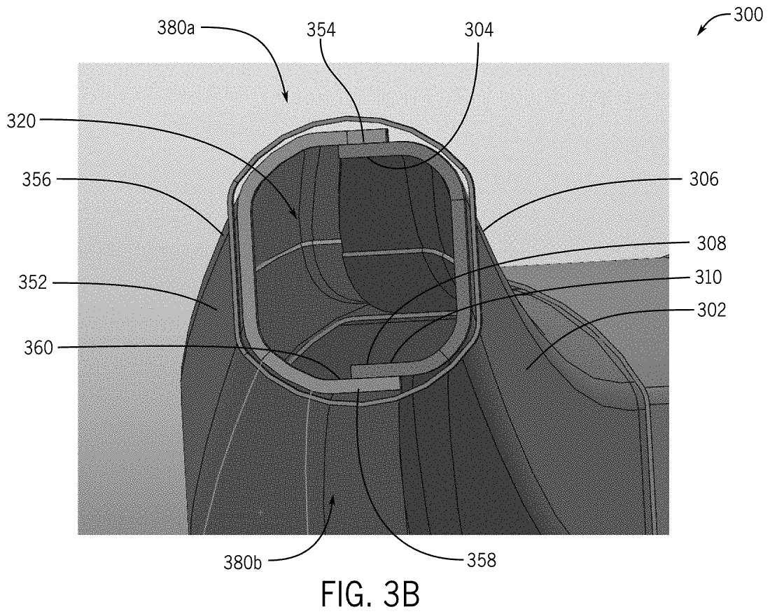

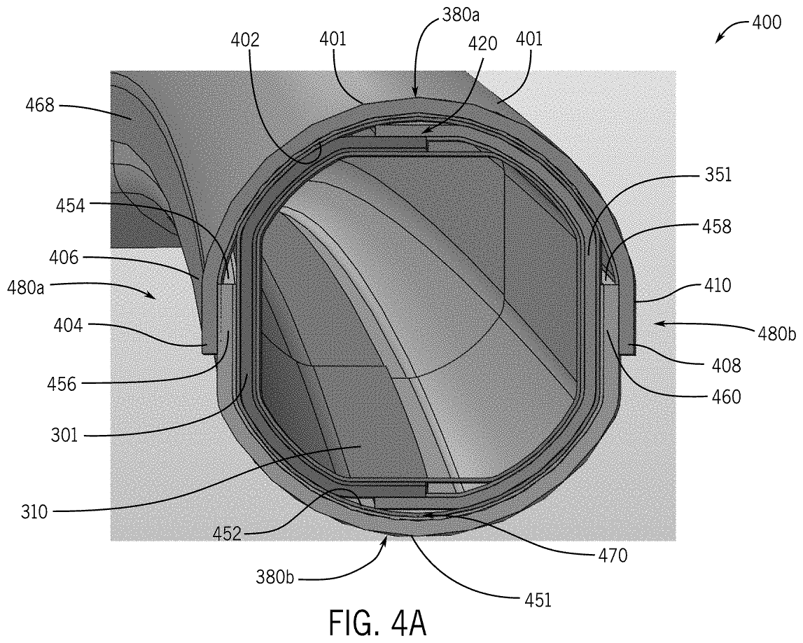

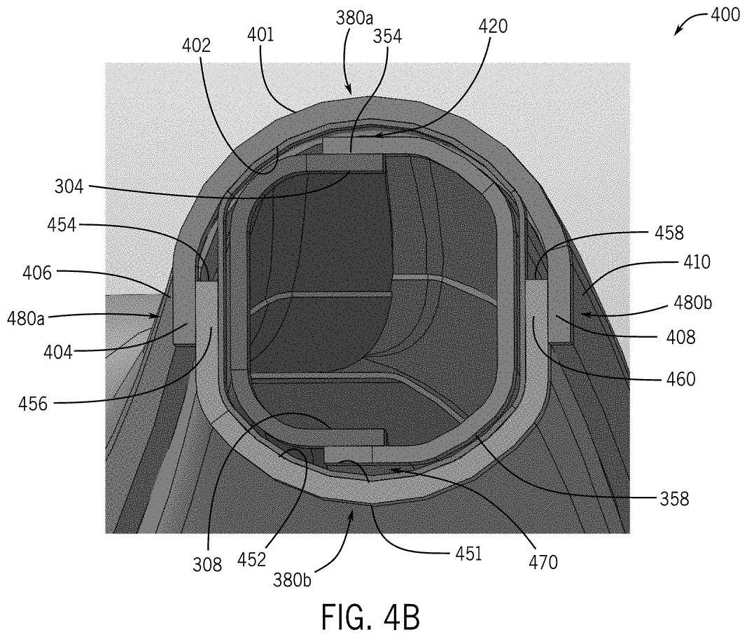

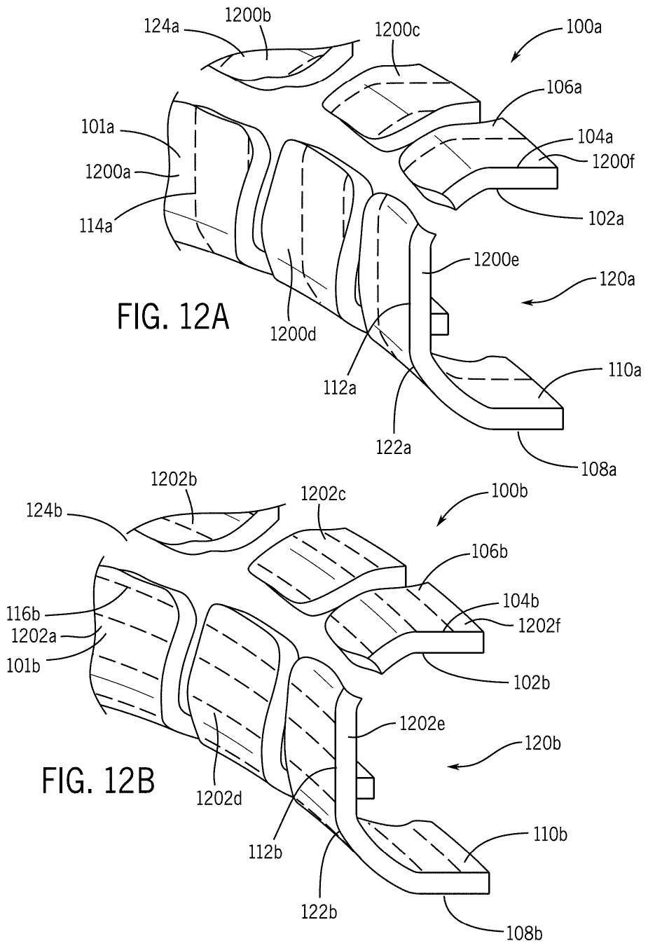

The substructure 100a can be formed with a reinforced thermoplastic material, such as any of the reinforced thermoplastic materials described herein. In this regard, the substructure 100a can include a thermoplastic material 101a having reinforcement fibers 114a arranged therewith. It will be appreciated that the reinforcement fibers 114a are shown in FIG. 1A in phantom line and schematically for purpose of illustration. In the example of FIG. 1A, the reinforcement fibers 114a can be arranged to extending along a generally radial direction of the substructure 100a. For example and as shown in FIG. 1A, the reinforcement fibers 114a can generally extend from the first end portion 104a to the second end portion 108a. The reinforcement fibers 114a can be spaced in any appropriate manner, including an even or spread tow distribution. The reinforcement fibers 114a can be arranged with the thermoplastic material 101a to enhance the damping characteristics of the resulting composite structure formed with the substructure 100a, such as the composite structures 300 and 400, described herein with respect to FIGS. 3A-4B. In some cases, the substructure 100a may define an initial substructure or initial composite substructure that can be recycled and repurposed into a recycled substructure or recycled composite structure, according to the systems and techniques described below in relation to FIGS. 12A-15.

With reference to FIG. 1B, a substructure 100b is shown. The substructure 100b can be substantially analogous to the substructure 100a of FIG. 1A and include: a clamshell-type shape 102b, a first end portion 104b, a first overlap region 106b, a second end portion 108b, a second overlap region 110b, a middle portion 112b, a concave region 120b, a first longitudinal end 122b, a second longitudinal end 124a, and a thermoplastic material 101b, which is reinforced with fibers.

Notwithstanding the foregoing similarities, the thermoplastic material 101b includes reinforcement fibers 116b. The reinforcement fibers 116b can be arranged extending along a generally axial direction of the substructure 100b. For example and as shown in FIG. 1B, the reinforcement fibers 116b can generally extend from the first longitudinal end 122b to the second longitudinal end 124b. The reinforcement fibers 114b can be spaced in any appropriate manner, including an even or spread tow distribution. The reinforcement fibers 114b can be arranged with the thermoplastic material 101b to enhance the damping characteristics of the resulting composite structure formed with the substructure 100b, such as the composite structures 300 and 400, described herein with respect to FIGS. 3A-4B. In some cases, the substructure 100b may define an initial substructure or initial composite substructure that can be recycled and repurposed into a recycled substructure or recycled composite structure, according to the systems and techniques described below in relation to FIGS. 12A-15.

With reference to FIG. 1C, a substructure 100c is shown. The substructure 100c can be substantially analogous to the substructure 100a of FIG. 1A and include: a clamshell-type shape 102c, a first end portion 104c, a first overlap region 106c, a second end portion 108c, a second overlap region 110c, a middle portion 112c, a concave region 120c, a first longitudinal end 122c, a second longitudinal end 124c, and a thermoplastic material 101c, which is reinforced with fibers.

Notwithstanding the foregoing similarities, the thermoplastic material 101c includes reinforcement fibers 114c. The reinforcement fibers 114c can be arranged extending generally off-axis through the substructure 100c. For example and as shown in FIG. 1C, the reinforcement fibers 114c can generally extending at an angle to the axial direction of the substructure 100c. In some cases, the reinforcement fiber 114c can define a spiral pattern, twist or weave and can be combined or otherwise associated with reinforcement fibers extending in the radial or axial direction. In this regard, the reinforcement fibers 114c can be arranged with the thermoplastic material 101c to enhance the damping characteristics of the resulting composite structure formed with the substructure 100c, such as the composite structures 300 and 400, described herein with respect to FIGS. 3A-4B. In some cases, the substructure 100c may define an initial substructure or initial composite substructure that can be recycled and repurposed into a recycled substructure or recycled composite structure, according to the systems and techniques described below in relation to FIGS. 12A-15.

With reference to FIG. 1D, a substructure 100d is shown. The substructure 100d can be substantially analogous to the substructure 100a of FIG. 1A and include: a clamshell-type shape 102d, a first end portion 104d, a first overlap region 106d, a second end portion 108d, a second overlap region 110d, a middle portion 112d, a concave region 120d, a first longitudinal end 122d, a second longitudinal end 124d, and a thermoplastic material 101d, which is reinforced with fibers.

Notwithstanding the foregoing similarities, the thermoplastic material 101d includes axial fibers 116d and radial fibers 114d. The axial fibers 116d are shown in FIG. 1D extending substantially between the first longitudinal end 122d and the second longitudinal end 124d. The radial fibers 114d are shown in FIG. 1D extending substantially between the first end portion 104a and the second end portion 108d. The axial and radial fibers 116d, 114d, can be arranged with the thermoplastic material 101d to enhance the damping characteristics of the resulting composite structure formed with the substructure 100d, such as the composite structures 300 and 400, described herein with respect to FIGS. 3A-4B. In some cases, the substructure 100d may define an initial substructure or initial composite substructure that can be recycled and repurposed into a recycled substructure or recycled composite structure, according to the systems and techniques described below in relation to FIGS. 12A-15.

With reference to FIG. 1E, a substructure 100e is shown. The substructure 100e can be substantially analogous to the substructure 100d of FIG. 1D and include: a clamshell-type shape 102e, a first end portion 104e, a first overlap region 106e, a second end portion 108e, a second overlap region 110e, a middle portion 112e, a concave region 120e, a first longitudinal end 122e, a second longitudinal end 124e, and a thermoplastic material 101e, which is reinforced with fibers, such as radial fibers 114e.

Notwithstanding the foregoing similarities, the thermoplastic material 101e is further reinforced with axial fibers 116e′. The axial fibers 116e′ are discontinuous or short fibers, as indicated by the broken phantom line in FIG. 1E. For example, the radial fibers 114e can be substantially continuous or long fibers and extend between opposing ends of the substructure 100e. The axial fibers 116e′ can generally be shorter fibers with breaks or discontinuities along the axial direction of the substructure 100e. In some cases, the thermoplastic material 101e can include continuous and discontinuous axial fibers. In some cases, the substructure 100e may define an initial substructure or initial composite substructure that can be recycled and repurposed into a recycled substructure or recycled composite structure, according to the systems and techniques described below in relation to FIGS. 12A-15.

With reference to FIG. 1F, a substructure 100f is shown. The substructure 100f can be substantially analogous to the substructure 100d of FIG. 1D and include: a clamshell-type shape 102f, a first end portion 104f, a first overlap region 106f, a second end portion 108f, a second overlap region 110f, a middle portion 112f, a concave region 120f, a first longitudinal end 122f, a second longitudinal end 124f, and a thermoplastic material 101f, which is reinforced with fibers, such as axial fibers 116f.

Notwithstanding the foregoing similarities, the thermoplastic material 101f is further reinforced with radial fibers 114f′. The radial fibers 114f′ are discontinuous or short fibers, as indicated by the broken phantom line in FIG. 1F. For example, the axial fibers 116e can be substantially continuous or long fibers and extend between opposing ends of the substructure 100f. The radial fibers 114f′ can generally be shorter fibers with breaks or discontinuities along the axial direction of the substructure 100e. In some cases, the thermoplastic material 101f can include continuous and discontinuous axial fibers. In some cases, the substructure 100f may define an initial substructure or initial composite substructure that can be recycled and repurposed into a recycled substructure or recycled composite structure, according to the systems and techniques described below in relation to FIGS. 12A-15.

The substructures described herein can be selectively reinforced with additional fiber reinforcement. The additional fiber reinforcement can be in the form of a hoop-wound layer over the substructure that defines a reinforcement structure over and/or about the substructure. Other forms are contemplated herein, including certain tapes, laminates, sheets, rolls and so on, including thermoplastic materials reinforced with the additional fiber reinforcement. The reinforcement structure can be selectively applied to the substructure in order to strength select regions or portions of the substructure, such as those regions portions that can be subject to greater applied loads.

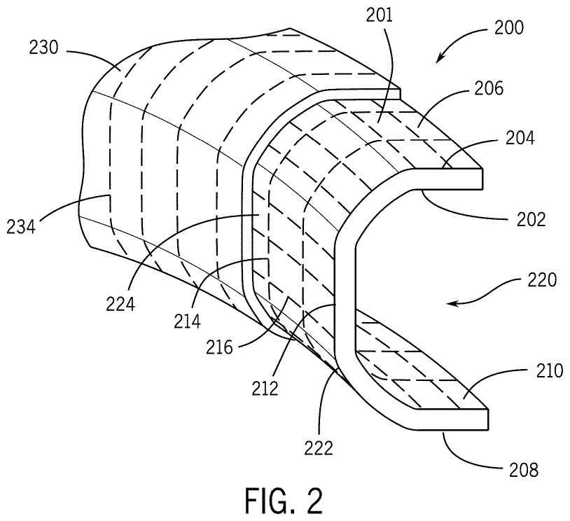

With reference to FIG. 2, a substructure 200 is shown having a reinforcement structure 230. The substructure 200 can be substantially analogous to the substructure 100d of FIG. 1D and include: a clamshell-type shape 202, a first end portion 204, a first overlap region 206, a second end portion 208, a second overlap region 210, a middle portion 212, a concave region 220, a first longitudinal end 222, a second longitudinal end 224, and a thermoplastic material 201, which is reinforced with fibers, such as radial fibers 214 and axial fibers 216.

The substructure 200 is shown with the reinforcement structure 230 applied to a selected portion of the clamshell-type shape 202. The reinforcement structure 230 includes reinforcement fibers 234. The reinforcement fibers 234 can be fibers that are wound about and around the clamshell-type shape 202. In other cases, the reinforcement fibers 234 can be fibers that are wound about a tubular shape defined by the substructure 200 and another substructure. As shown in FIG. 2, the fibers 234 can extend in a generally radial direction of the substructure 200. In this regard, the fibers 234 can extend substantially transverse to a direction of at least a subset of fibers of the substructure 200, such as the axial fibers 216.

FIGS. 3A and 3B depict an example composite structure 300. The composite structure 300 is shown as including a first substructure 301 and a second substructure 351. The first and second substructures 301, 351 can be substantially analogous to any of the substructures described herein, such as any of the substructures 100a-100f of FIGS. 1A-1F and variations and combinations thereof. In this regard, the first substructure 301 is shown in FIGS. 3A and 3B as including: a clamshell-type shape 302, a first end portion 304, a first overlap region 306, a second end portion 308, a second overlap region 310, a middle portion 312, a concave region 320. Further, second substructure 351 is shown in FIGS. 3A and 3B as including: a clamshell-type shape 352, a first end portion 354, a first overlap region 356, a second end portion 358, a second overlap region 360, a middle portion 362, a concave region 370. The composite structure 300 can be selective reinforced, and include a reinforcement structure 330, which can be substantially analogous to any of the reinforcement structures described above.

In the example of FIGS. 3A and 3B, the first substructure 301 and the second substructure 351 can be associated with one another to define a tubular structure 368. For example, the clamshell-type shape 302 of the first substructure 301 can be arranged with the concave region 320 facing the concave region 370 of the clamshell-type shape 352 of the second substructure 351. The arrangement of the first and second substructures 301, 351 can combine the concave regions 320, 370 to define a tubular volume 374 of the tubular structure 368. The tubular structure 368 can be configured to exhibit one or more of the damping characteristics described herein, based in part on the configuration of the reinforcement fibers, as shown in FIGS. 1A-1F.

In the example of FIGS. 3A and 3B, the first and second substructures 301, 351 are associated with one another with opposing ends of the first substructure 301 connected to the opposing ends of the second substructure 351. By way of illustration, the first end portion 304 of the first substructure 301 can be connected, such as being overlapped, with the first end portion 354 of the second substructure 351. For example, the first overlap region 306 of the first end portion 304 can be slid against and received under the first overlap region 356 of the first end portion 354. In this regard, the first overlap region 306 and the first overlap region 356 can overlap to define a first joint 380a. The first joint 380a can be a lap joint, scarf joint, or other appropriate joint or connection. In one example, the first joint 380a defines an overlapped section of the overlap regions 306, 356 that measures at least about 0.01 inches, at least about 0.02 inches, at least about 0.03 inches, or greater. In some cases, the overlap is sufficient to establish a continuous seam between the first and second substructures 301, 351, such as through the application of heat and pressure. The second end portion 308 of the first substructure 301 and the second end portion 358 of the second substructure 351 can be joined in a substantially analogous manner to the first end portions 304, 354 in order to define a second joint 380b. The first and second joints 380a, 380b can be spaced approximately 180° apart from one another.

FIGS. 4A and 4B depict an example composite structure 400. The composite structure 400 is shown as including the first substructure 301 and the second substructure 351, as shown in FIGS. 3A-3B. The composite structure 400 further includes a third substructure 401 and a fourth substructure 451. The third and fourth substructures 401, 451 can be substantially analogous to any of the substructures described herein, such as any of the substructures 100a-100f of FIGS. 1A-1F and variations and combinations thereof. In this regard, the first substructure 401 is shown in FIGS. 4A and 4B as including: a clamshell-type shape 402, a first end portion 404, a first overlap region 406, a second end portion 408, a second overlap region 410, a middle portion 412, a concave region 420. Further, second substructure 451 is shown in FIGS. 4A and 4B as including: a clamshell-type shape 452, a first end portion 454, a first overlap region 456, a second end portion 458, a second overlap region 460, a middle portion 462, a concave region 470. The composite structure 400 can be selective reinforced, and include a reinforcement structure 430, which can be substantially analogous to any of the reinforcement structures described above.

In the example of FIGS. 4A and 4B, the third substructure 401 and the fourth substructure 451 can be associated with one another to define an outer tubular structure 468. For example, the clamshell-type shape 402 of the third substructure 401 can be arranged with the concave region 420 facing the concave region 470 of the clamshell-type shape 452 of the fourth substructure 451. The outer tubular structure 469 can be fitted over the tubular structure 368 defined by the first and second substructures 301, 351 so that the composite structure 400 is defined by the arrangement of the first, second, third, fourth substructures 301, 351, 401, 451 as shown in FIGS. 4A and 4B.

The third substructure 401 and the fourth substructure 451 can be associated with one another in a manner substantially analogous to the association of the first substructure 301 and the second substructure 351. For example, the first end portions 404, 454 can overlap to define a third joint 480a and the second end portions 408, 458 can overlap to define a fourth joint 480b. The third and fourth joints 480a, 480b can be spaced approximately 180° apart from one another. The third and fourth joints 480a, 480b can be spaced approximately 90° apart from each of the first and second joints 380a, 380b

The composite structures of the present disclosure can exhibit enhanced damping characteristics. For example and described above, the composite structures can be configured to exhibit a damping coefficient of greater than about 0.5 lbf s/in. Additionally or alternatively, the composite structures disclosed herein can be configured to limit vibrations to a value of less than about 5.0 m/s2. In this regard, the composite structures can satisfy the ISO 5349-1:2001 standard for safe levels of damping. The composite structures can also satisfy other ISO standards associated with mechanical damping, including the ISO 4210-5 standard for minimum safe structural levels of damping in a handlebar of a bicycle.

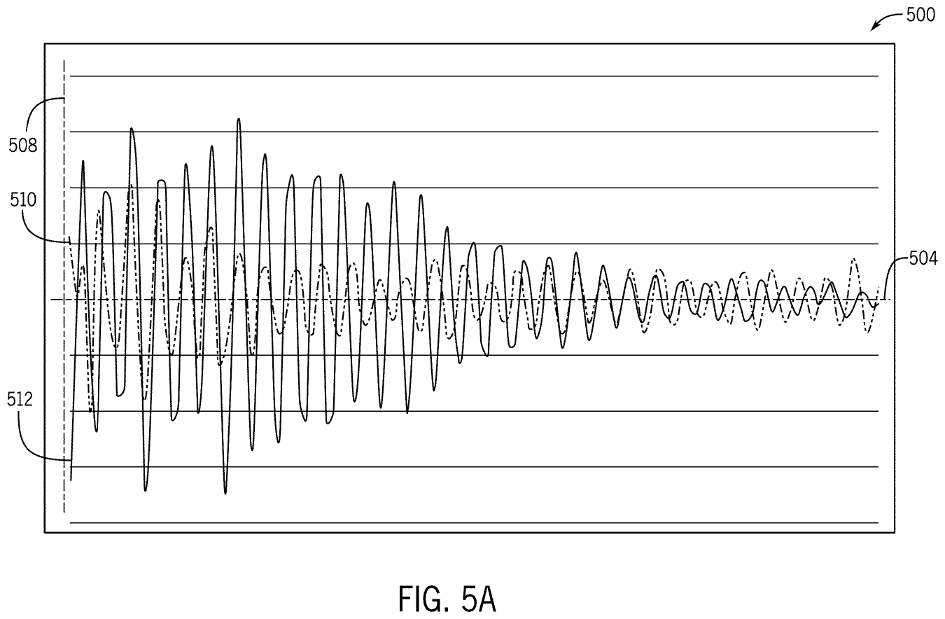

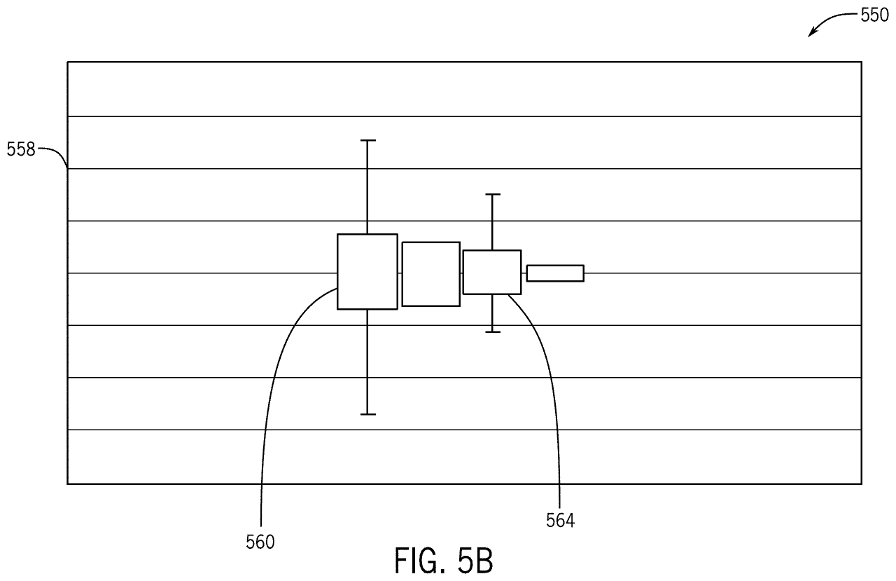

The composite structures formed from a reinforced thermoplastic material can be configured to exhibit damping characteristics that are enhanced over conventional thermoset structures. With reference to FIG. 5A, a chart 500 is shown that depicts example angular velocity curves for a composite structure of the present disclosure compared to conventional thermoset structures. For example, the chart 500 includes an incremental x-axis 504 corresponding to a measurement of time. The chart 500 further includes an angular velocity y-axis 508. The chart 500 further includes a first curve 510 and second curve 512 plotted relative to the x-axis 504 and the y-axis 508. The first curve 510 can be indicative of the angular velocity of a portion of a composite structure of the present disclosure, such as tubular handlebar structure, when subject to an applied load, drop condition, or other force in which a vibratory motion is induced in the composite structure. The second curve 512 can be indicative of the angular velocity of a portion of a thermoset structure, such as a handlebar structure, when subjected to the same conditions as those of the composite structure represented by the curve 510.

As shown in chart 500, the curve 510 of the composite structure generally has a lesser angular velocity amplitude for each increment along the x-axis as compared with the curve 512, which represents the thermoset structure. Further, the amplitude of the curve 510 generally decays at a faster rate as compared with the decay of the amplitude of the curve 512. Accordingly, when subjected to similar initial conditions, the composite structure of the present disclosure can be configured to vibrate less and return to a steady state sooner, as compared with a thermoset structure. This relationship can represented by the damping coefficient. For example, the thermoset structure represented by the curve 512 can have a damping coefficient of around 0.15 to 0.19 lbf(sec/in). The composite structure represented by the curve 510 can have a damping coefficient of at least 0.25 lbf(sec/in), at least 0.35 lbf(sec/in), at least 0.5 lbf(sec/in), or greater.

To illustrate the foregoing, FIG. 5B depicts a chart 550 that shows example angular velocity distributions for the curve 510 and the curve 512. The chart 550 includes an angular velocity y-axis 558. The chart 550, further includes a box-plot element 560 which is representative of the distribution of the angular velocity values of the curve 512. The chart further includes a box-plot element 564 which is representative of the distribution of the angular velocity values of the curve 510. The box-plot element 560 shows the angular velocity values for the thermoset structure represented by the curve 512 are distributed over a wider range than the angular velocity values for the composite structure represented by the curve 510. For example, the box portion of the box-plot element 564 is substantially smaller than the box portion of the box-plot element 560.

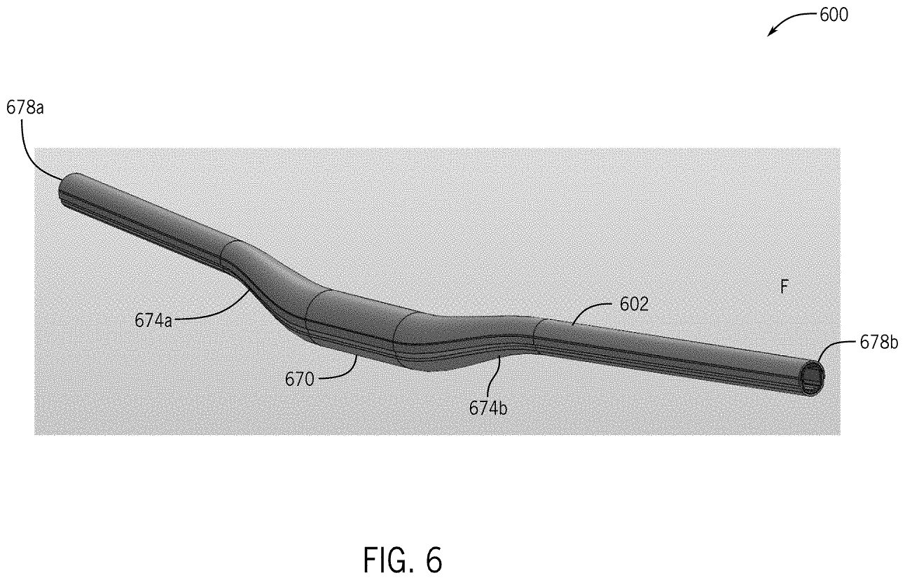

The composite structures of the present disclosure can be used to form substantially tubular structure for use in various applications. For example and with reference to FIG. 6, a handlebar structure 600 is shown. The handlebar structure 600 can be formed substantially from a composite structure 602, such as any of the composite structure described herein. In this regard, the composite structure 602 can include two or more substructures formed from a reinforced thermoplastic material. The reinforced thermoplastic material can include fibers having one or more of the orientations shown above with reference to FIGS. 1A-1E. The fibers can be arranged in the substructures of the composite structure 600 such that the handlebar structure 600 exhibits one or more of the enhanced damping characteristics described herein. For example, the handlebar structure can be configured to exhibit a damping coefficient of greater than about 0.5 lbf s/in. Additionally or alternatively, the composite structures disclosed herein can be configured to limit vibrations to a value of less than about 5.0 m/s2. In this regard, curve 510 described above with respect to FIG. 5A can be indicative of the handlebar structure 600.

While many constructions are possible, the handlebar structure 600 is shown as including a middle portion 670, a first end 678a, and a second end 678b. The handlebar structure 600 can generally be an elongated structure extending between the first and second ends 678a, 678b. The first and second ends 678a, 678b can be adapted to allow a user to grip and engage the handlebar structure during use while operating a bicycle. The middle portion 670 can be a thicker portion of the handlebar structure 600 that is connected to the first end 678a via a first transition portion 674a. The middle portion 670 can be connected to the second end via second transition portion 674b.

In some cases, it can be desirable to reinforce one or more portions of the handlebar structure. For example, the first and second ends 678a, 678b, and/or the middle portion 670 can be subjected to additional loading during use. As an illustration, the middle portion 670 can facilitate a connection to a stem, headset, tube, frame, and the first and second ends 678a, 678b can facilitate a connection to a user's arms. During operation of the bicycle, loading from the frame at the middle portion 670 and the user's arms at the first and second ends 678a, 678b can induce stress through the handlebar structure 600, which can lead to vibration.

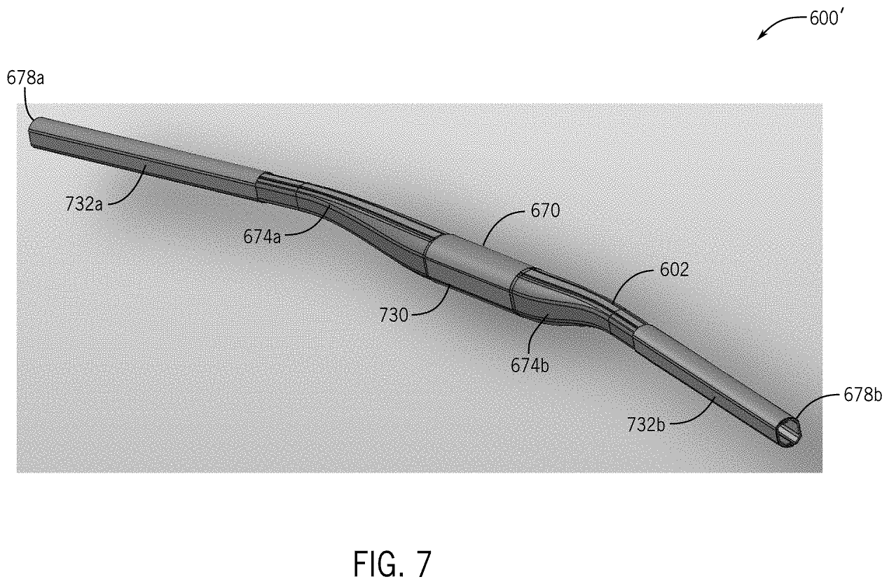

Accordingly, the handlebar structure 600 can be reinforced with a reinforcement structure, such as any of the reinforcement structures described herein (e.g., the reinforcement structure 230 of FIG. 2). In this regard, FIG. 7 shows a reinforced handlebar structure 600′. The reinforced handlebar structure 600′ is shown in FIG. 7 as including a first end reinforcement structure 732a at the first end 678a and a second end reinforcement structure 732b at the second end 678b. FIG. 7 further shows a middle portion reinforcement structure 730 at the middle portion 670. Each of the reinforcement structures 732a, 732b, 730 can include reinforcement fibers that are hoop-wound about the composite structure 602. For example, the reinforcement fibers can be hoop-wound about individual substructures of the composite structure 602. Additionally or alternatively, the reinforcement fibers can be hoop-wound completely about the composite structure 602.

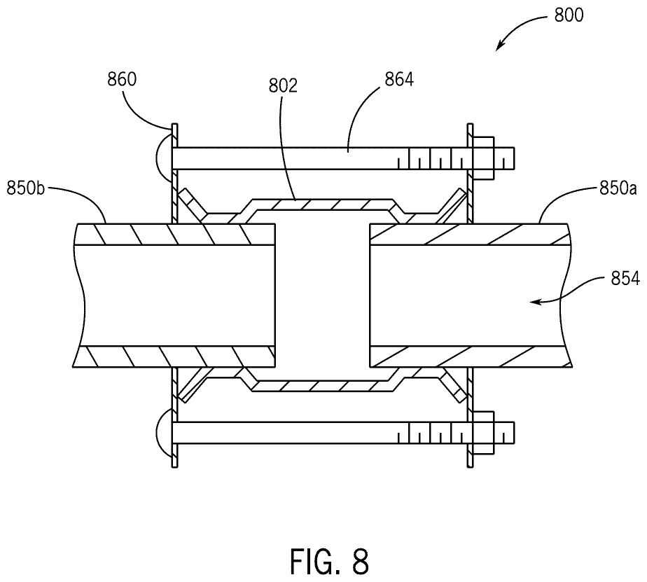

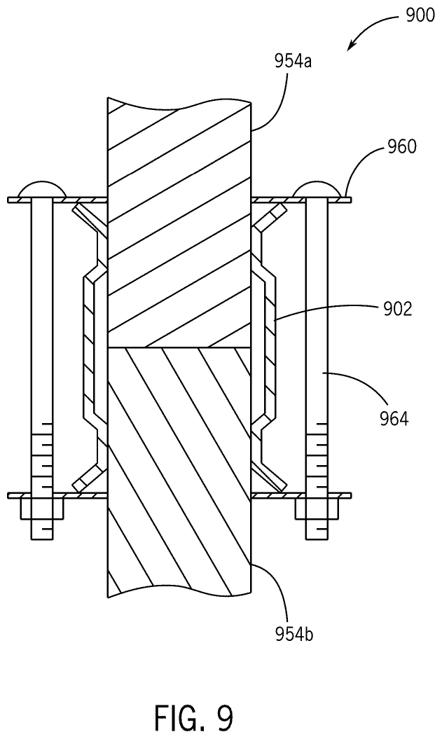

The composite structures of the present disclosure can be implemented in a variety of contexts in order to induce a damping effect in a mechanical system. As one example, FIG. 8 depicts a pipe coupling 800 including a composite structure 802. The composite structure 802 can be substantially analogous to any of the composite structures 802 described herein. The pipe coupling 800 is shown in FIG. 8 as being adapted to fluidly couple a first pipe 850a and a second pipe 850b. The first and second pipes 850a, 850b can abut one another and fit inside the tubular composite structure 802. The composite structure 802 can be seated within a frame 860. The frame 860 can operate to compress the composite structure 802 using a fastener 864. In operation, the pipes 850a, 850b can experience vibrations, such as from fluid hammer and the like, that left unmitigated can travel for substantial lengths of a pipeline. The composite structure 802 can provide a connection between the pipes 850a, 850b that reduces or dampens such vibration. For example, the composite structure 802 can have various arrangements of fibers reinforcing thermoplastic substructures of the composite structure that are configured to reduce the vibration of the composite structure, as described herein.

Other implementations of the composite structure are possible and contemplated herein. For example, FIG. 9 shows a structural element coupling 900 including a composite structure 902 of the present disclosure. The structural element coupling 900 can be substantially analogous to the pipe coupling 800 and include: a composite structure 902, a frame 960, and fastener 964. The structural element coupling 900 can operate to join a first structural element 950a and a second structural element 950b, such as rebar. The composite structure 902 can induce certain damping characteristics between the first and second structural elements 950a, 950b.

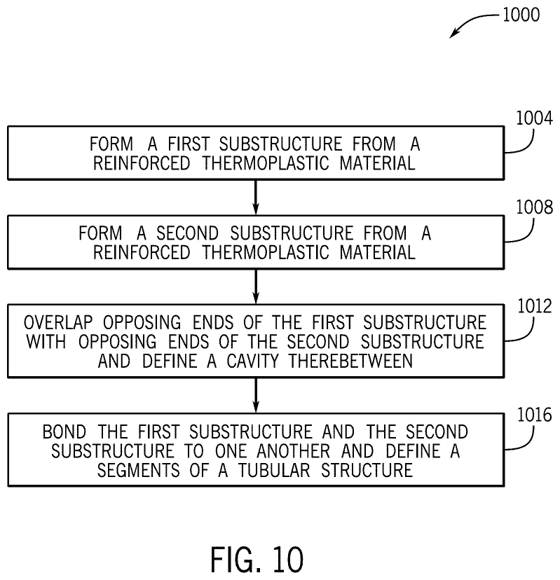

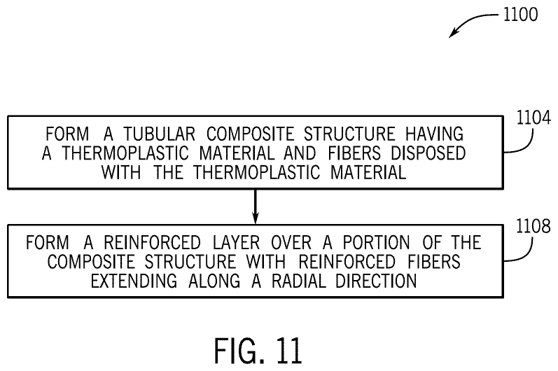

To facilitate the reader's understanding of the various functionalities of the embodiments discussed herein, reference is now made to the flow diagrams in FIGS. 10 and 11, which illustrates process 1000 and 1100. While specific steps (and orders of steps) of the methods presented herein have been illustrated and will be discussed, other methods (including more, fewer, or different steps than those illustrated) consistent with the teachings presented herein are also envisioned and encompassed with the present disclosure.

With reference to FIG. 10, a method 1000 for forming a composite structure is shown. At operation 1004, a first substructure can be formed from a reinforced thermoplastic material. For example and with reference to FIG. 3A, the first substructure 301 can be formed from a reinforced thermoplastic material. As shown in FIG. 1D, the reinforced thermoplastic material of the first substructure 301 can include radial fibers 114d and axial fibers 116d held in a thermoplastic material 101d. The radial and/or axial fibers 114d, 116d can be continuous, discontinuous and/or combination thereof.

At operation 1008, a second substructure can be formed from a reinforced thermoplastic material. For example and with reference to FIG. 3A, the second substructure 351 can be formed from a reinforced thermoplastic material. As shown in FIG. 1D, the reinforced thermoplastic material of the second substructure 351 can include radial fibers 114d and axial fibers 116d held in a thermoplastic material 101d. The radial and/or axial fibers 114d, 116d can be continuous, discontinuous and/or combination thereof.

At operation 1012, opposing ends of the first substructure can be overlapped with opposing ends of the second substructure. The operation 1012 can allow the first and second substructures to form a cavity therebetween. For example and as shown in FIG. 3, the first end portion 304 of the first substructure 301 is overlapped with the first end portion 354 of the second substructure 351 to define a first joint 380a. As further shown in FIG. 3, the second end portion 308 of the first substructure 301 is overlapped with the second end portion 358 of the second substructure 351 to define a second joint 380b. In the overlapped configuration, the first and second substructures 301, 351 can cooperate to define a tubular volume 374.

At operation 1016, the first substructure can be bonded with the second substructure. The operation 1016 can allow the first and second substructures to define a segment of a tubular structure. For example and with reference to FIG. 3, the first and second substructures 301, 351 can be subjected to heat and pressure in order to form the composite structure 300. The composite structure 300 can be a segment of a tubular structure.

With reference to FIG. 11, a method 1100 for reinforcing a composite structure is shown. At operation 1104, a tubular composite structure having a thermoplastic material and disposed with the thermoplastic material can be formed. For example and with reference to FIG. 3, the composite structure 300 can be formed by joining opposing ends of the first substructure 301 to opposing ends of the second substructure 351. The joined substructures 301, 351 can be subjected to heat and pressure, as described herein, to form a composite structure.

At operation 1108, a reinforcing layer can be formed over a portion of the composite structure. The reinforcing layer can have fibers extending along a radial direction of the tubular composite structure. For example and with reference to FIG. 7, one or more reinforcement structures can be formed over a portion of a composite structure 602 that defines a handlebar structure. For example, the first end reinforcement structure 732a can be formed over the first end 678a and the second end reinforcement structure 732b can be formed over the second end 678b. Further, the middle portion reinforcement structure 730 can be formed over the middle portion 670. Each of the reinforcement structures 732a, 732b, 730 can include reinforcement fibers that are hoop-wound about the composite structure 602.

Any of the composite structures and substructures describes herein may be processed in order to form a recycled composite structure. The processing of the composite structure or substructure (referred to herein as an “initial composite structure”) may generally involve breaking the initial composite structure into a plurality of constituent pieces. The initial composite structure may include a thermoplastic material and an arrangement of reinforcement fibers, such as having any of the fibers and/or arrangements shown in the examples of FIGS. 1A-1F described herein. In this regard, the each constitute piece of the of the initial composite structure may include a portion or segment of the thermoplastic material and the associated reinforcement fibers (if any) according to the arrangement of fibers in the initial composite structure. The constituent pieces of the initial composite structure may subsequently be arranged in a mold. In some cases, the constituent pieces of other composite structures may be added to the mold along with the pieces of the initial composite structure, including pieces having fibers arranged in different orientations or patterns. Subsequently, the pieces that are arranged in the mold may be bonded with one another in order to form a recycled composite structure from the constituent pieces. The consistent pieces may operate to define a patchwork-type arrangement of discontinuous reinforcement fibers within the continuous section.

For purposes of illustration, FIG. 12A presents separated pieces of the substructure 100a. For example, the substructure 100a (described in relation to FIG. 1A) may be broken, chopped, or otherwise separated into a first piece 1200a, a second piece 1200b, a third piece 1200c, a fourth piece 1200d, a fifth piece 1200e, and a sixth piece 1200f. The separation of the substructure 100a may occur by a variety of means, including a mechanical chopping, cutting, grinding, crushing, and/or other appropriate operation. As described herein, the substructure 100a may include the reinforcement fibers 114a that are disposed extending in a radial direction. For example, the reinforcement fibers 114a can extend generally from a first end portion 104a to a second end portion 108a. As illustrated in FIG. 12A, each of the pieces 1200a-1200f includes a portion of the reinforcement fibers 114a. The portion of the reinforcement fibers 114a that are included in each of the pieces 1200a-1200f, in the example of FIG. 12A, are each arranged in the radial orientation, consistent with the orientation of the reinforcement fibers of the initial substructure 100a. The arrangement of the reinforcement fibers in each of the pieces 1200a-1200f may define a first pattern of reinforcement fibers.

For purposes of illustration, FIG. 12B presents separated pieces of the substructure 100b. For example, the substructure 100b (described in relation to FIG. 1B) may be broken, chopped, or otherwise separated into a first piece 1202a, a second piece 1202b, a third piece 1202c, a fourth piece 1202d, a fifth piece 1202e, and a sixth piece 1202f. The separation of the substructure 100b may occur by a variety of means, including a mechanical chopping, cutting, grinding, crushing, and/or other appropriate operation. As described herein, the substructure 100b may include the reinforcement fibers 116a that are disposed extending in an axial direction. For example, the reinforcement fibers 116a can extend generally from a first longitudinal end 122a to a second longitudinal end 122b. As illustrated in FIG. 12B, each of the pieces 1202a-1202f includes a portion of the reinforcement fibers 116a. The portion of the reinforcement fibers 116a that are included in each of the pieces 1202a-1202f, in the example of FIG. 12B, are each arranged in the radial orientation, consistent with the orientation of the reinforcement fibers of the substructure 100b. The arrangement of the reinforcement fibers in each of the pieces 1202a-1202f may define a second pattern of reinforcement fibers.

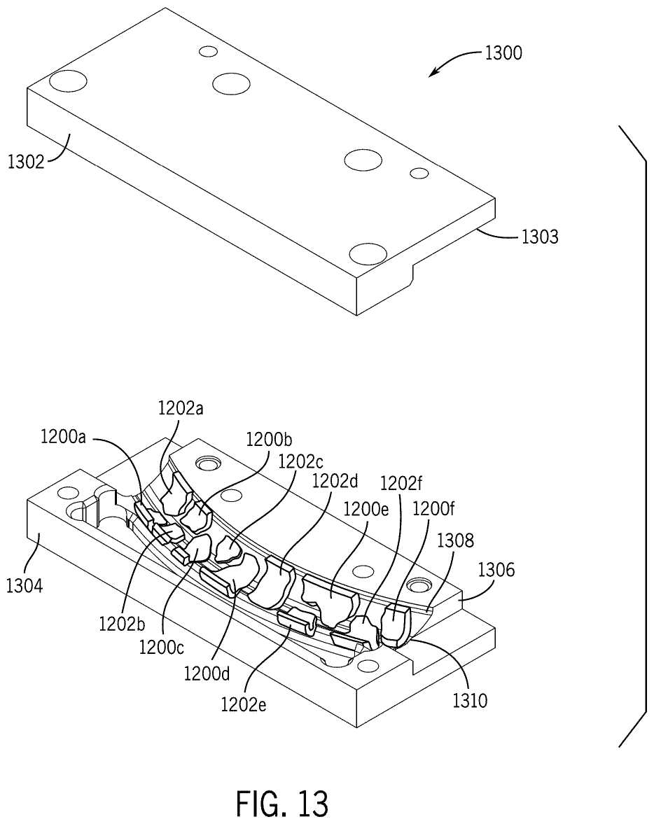

The separated pieces of the substrate of FIG. 12A and/or FIG. 12B may be recycled and molded to form a new composite structure. For example, pieces of the substructure 100a and/or the substructure 100b may be associated with a mold and bonded to one another using heat and pressure, according to any of the techniques described herein. For example, and as shown in FIG. 13, a mold assembly 1300 is provided. The mold assembly 1300 is shown as including a first mold piece 1302 and a second mold piece 1304. The first mold piece 1302 may include a first engagement surface 1303. The second mold piece 1304 is shown as being formed from a mold block 1306. The mold block 1306 may include a second engagement surface 1308. The second engagement surface 1308 may be a cavity of channel having a series of shaping features 1310 defined therein.

As shown in FIG. 13, pieces of the substrate 100a and the substrate 100b may be arranged in the mold for forming a recycled component from the constituent broken pieces of the initial composite structures. By way of particular example, the pieces 1200a-1200f of the substrate 100a are shown disposed along the engagement surface 1308. Further, the pieces 1202a-1202f are also shown disposed along the engagement surface 1308. The pieces 1200a-1200f and the pieces 1202a-1202f are shown intermixed with one another along the engagement surface 1308. In some cases, the pieces 1200a-1200f, 1202a-1202f may be overlapping abutting, or otherwise contacting one another in any appropriate manner.

The pieces 1200a-1200f, 1202a-1202f may serve as the constituent materials for forming the recycled composite structure. For example, the pieces 1200a-1200f, 1202a-1202f may be arranged along the engagement surface 1308 and pressed and heat together in the mold assembly 1300 in order to form the recycled composite structure. In one operation, the first mold piece 1302 may be coupled with the second mold piece 1304. The first and second mold pieces 1302, 1304 may be coupled with one another in a manner that compresses and forms the pieces 1200a-1200f, 1202a-1202f to one another. The mold assembly 1300 may further operate to heat the pieces 1200a-1200f, 1202a-1202f in order to melt or partially melt said pieces and allow said pieces to bond to one another. In this regard, the mold assembly 1300 may causes the pieces 1200a-1200f, 1202a-1202f to form with one another, thereby permitting the thermoplastic materials of said pieces to intermix and bond to one another in a manner that creates a substantially continuous, optionally seamless component in the shape of the mold.

The pieces 1200a-1200f, 1202a-1202f may each have reinforcement fibers in a particular defined pattern, as described above in relation to FIGS. 12A and 12B. The pieces 1200a-1200f, 1202a-1202f may bond to one another with the thermoplastic materials of each component being melted, and joining with melted thermoplastic material of an adjacent piece. Each piece may include the pattern of fibers as defined by the initial composite structure. For example, one of the pieces 1200a-1200f may have reinforcement fibers in the radial orientation, whereas one of the pieces 1202a-1202f may have reinforcement fibers in the axial orientation. The pieces 1200a-1200f, 1202a-1202f may be arranged in any manner, including a random manner, in the mold assembly 1300. In this regard, the bonding of adjacent pieces may set a first pattern of reinforcement fibers (e.g., a radial pattern) adjacent to a second pattern of reinforcement fibers (e.g., an axial pattern). The adjacent pieces may be bonded to one another via the thermoplastic material, while the reinforcement fibers of each adjacent piece may be discontinuous and off-axis with one another based on the arrangement of fibers in the initial composite material. In this regard, while the pieces may be substantially continuous and seamless, the pieces may collectively define a patchwork type pattern with respect to the various orientations and arrangements of fibers in the component.

For purposes of illustration, the mold assembly 1300 is shown in FIG. 13 with respect to manufacturing a bicycle rim feature or wheel. For example, the first and second engagement surfaces 1303, 1308 may be opposing surfaces of bicycle wheel wall or other segment of circumferential component such that when the engagement surface 1303, 1308 are pressed toward one another the material disposed therebetween may be formed into said shape. The recycled composite structures of the present application are not limited to the circumferential shape shown in FIG. 13. It will be appreciated that, for example, the pieces 1200a-1200f, 1202a-1202f may be arranged with a mold of a variety of types and shapes, including complex shapes of any type and size. Further, it will be appreciated that the pieces 1200a-1200f, 1202a-1202f may be arranged in a mold having a shape that is different from the shape of the initial composite structure.

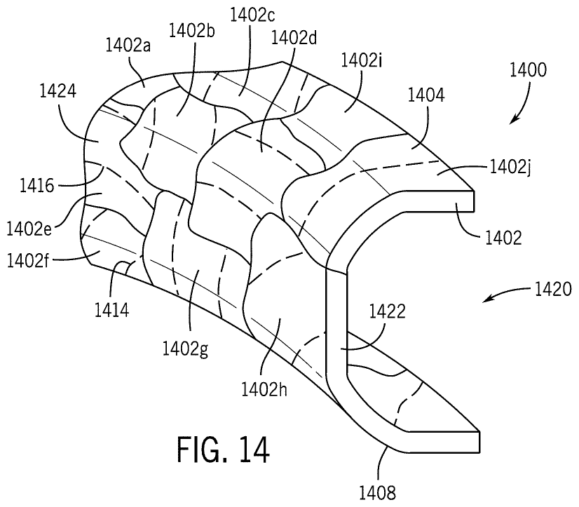

As one illustrative example of a shape formable by the techniques described herein, FIG. 14 shows a substructure 1400. In the example of FIG. 14, the substructure 1400 may define a generally clamshell-type shape 1402 having a first end portion 1404, a second end portion 1408, a concave region 1420, a first longitudinal end 1422, and a second longitudinal end 1424. In other examples, other shapes are contemplated herein.

The substructure 1400 may be formed from a plurality of pieces of the substrate 100a and/or the substrate 100b and/or substantively any of the other substrates described herein (e.g., the constituent pieces may be pieces from any of the substrates 100a-100f shown and described in relation to FIGS. 1A-1F). For example, the substructure 1400 is shown as including and being formed from a first piece 1402a, a second piece 1402b, a third piece 1402c, a fourth piece 1402d, a fifth piece 1402e, a sixth piece 1402f, a seventh piece 1402g, an eighth piece 1402h, a ninth piece 1402i, and a tenth piece 1402j. The pieces 1402a-1402j may be pieces that are processed from a portion of any of the substructures 100a-100f of FIGS. 1A-1F. Stated differently, any of the substructures 100a-100f may be broken into pieces and combined with one another to form the substructure 1400 of FIG. 14.

In this regard, each of the pieces 1402a-1402j may have reinforcement fibers. The reinforcement fibers of any respective one of the pieces 1402a-1402j may have different orientations as compared to reinforcement fibers of an adjacent piece 1402a. For example, the sixth piece 1402f may have radial fibers 1414 (e.g., where the sixth piece 1402f is a piece processed from a substructure having radial fibers). Further, the fifth piece 1402e may have axial fibers 1416 (e.g., where the fifth piece 1402e is a piece processed from a substructure having axial fibers). As shown in FIG. 14, the fifth piece 1402e and the sixth piece 1402f are bonded to one another in order to form a substantially continuous section of the composite structure 1400. Notwithstanding, the fibers of the fifth piece 1402e and the sixth piece 1402f may be discontinuous or off-axis with one another. The arrangement of the fibers in this manner may be configured to enhance material properties of the compute structure, such as by establishing a damping coefficient great than 0.5 lbf s/in and/or a characteristic in which vibrations of the composite structure are less than 5.0 m/s2.

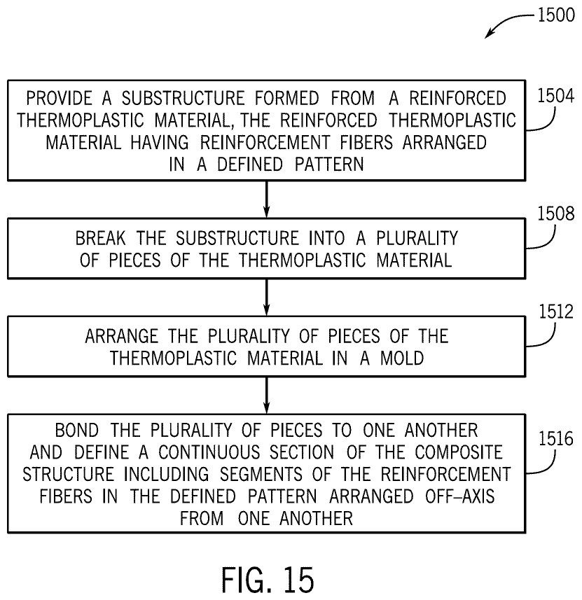

FIG. 15 depicts a flow diagram forming reinforced thermoplastic substructures formed from recycled pieces. At operation 1504, a substructure formed from a reinforced thermoplastic material is provided. The reinforced thermoplastic material includes reinforcement fibers arranged in a defined pattern. For example, and with reference to FIGS. 1A and 1B, the substructure 100a and/or the substructure 100b may be provided. The substructure 100a may have fibers arranged in a first defined pattern, such as in an a radial pattern. The substructure 100b may have reinforcement fibers arranged in a second defined pattern, such as an axial pattern.

At operation 1508, the substructure is broken into a plurality of pieces of the thermoplastic material. For example, and with reference to FIGS. 12A and 12B, the first substructure 100a may be broken into constituent pieces 1200a, 1200b, 1200c, 1200d, 1200e, 1200f. Each of the pieces 1200a-1200f may have fibers in the radial direction. Further, and optionally, the second substructure 100b may be broken into constituent pieces 1202a, 1202b, 1202c, 1202d, 1202e, 1202f. Each of the pieces 1202a-1202f may have fibers in the axial direction.

At operation 1512, the plurality of pieces of the thermoplastic material may be arranged in a mold. For example, and with reference to FIG. 13, the pieces 1200a-1200f may be arranged in the mold assembly 1300. Further, the pieces 1202a-1202f may be arranged in the mold assembly 1300. At operation 1516, the plurality of pieces are bonded to one another and define a continuous section of the composite structure including segments of the reinforcement fibers in the defined pattern and arranged off-axis from one another. For example, and with reference to FIGS. 13 and 14, the mold assembly 1300 may be operated to press the first mold piece 1302 and the second mold piece 1304 toward one another with the pieces 1200a-1200f and 1202a-1202f arranged therebetween. Heat and pressure may be applied to the pieces in order cause a bonding of the thermoplastic material of adjacent and/or overlapped pieces. In turn, the bonded thermoplastic material may define a recycled composite structure formed from the constituent pieces. The recycled composite structure may include reinforcement fibers in a variety of patterns and configurations based on the reinforcement fibers of the initial composite structures. For example, the recycled composite structure may have the reinforcement fibers in a first pattern and in a second pattern. The fibers of the first pattern may be off-axis and discontinuous with the fibers of an adjacent second pattern.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A composite structure, comprising:
a thermoplastic material; and
axial fibers and radial fibers arranged within the thermoplastic material;
wherein the thermoplastic material defines a substructure of the composite structure.

2. The composite structure of claim 1, wherein:
the substructure comprises a first substructure;
the composite structure further comprises a second substructure; and
opposing ends of the first substructure and the second substructure are bonded with one another to form a tubular structure.

3. The composite structure of claim 2, wherein the tubular structure has a damping coefficient greater than 0.5 lbf s/in.

4. The composite structure of claim 2, wherein vibrations of the tubular structure are less than 5.0 m/s2.

5. The composite structure of claim 2, further comprising a reinforcement substructure formed over one or both of the first substructure or the second substructure.

6. The composite structure of claim 5, wherein the reinforcement substructure comprises complete or partial hoop windings of a reinforcement fiber.

7. The composite structure of claim 1, wherein a subset of one or both of the axial fibers or the radial fibers are discontinuous.

8. A composite structure, comprising:
a first substructure formed from a reinforced thermoplastic material; and
a second substructure formed from a reinforced thermoplastic material;
wherein opposing ends of the first substructure and the second substructure overlap to define a tubular structure; and
wherein the overlap is greater than 0.030″ in either an axial or a radial direction.

9. The composite structure of claim 8, wherein the overlap defines a scarf joint.

10. The composite structure of claim 8, further comprising:
a third substructure formed from a reinforced thermoplastic material; and
a fourth substructure formed from a reinforced thermoplastic material;
wherein the tubular structure comprises an inner tubular structure; and
wherein opposing ends of the third substructure and the fourth substructure overlap to define an outer tubular structure over the inner tubular structure.

11. The composite structure of claim 8, further comprising a reinforcement substructure formed over one or both of the first substructure or the second substructure.

12. The composite structure of claim 11, wherein the reinforcement substructure comprises complete or partial hoop windings of a reinforcement fiber.

13. A composite structure comprising
a first substructure formed from a reinforced thermoplastic material including reinforcement fibers arranged in a first pattern; and
a second substructure formed from a reinforced thermoplastic material including reinforcement fibers arranged in a second pattern;
wherein the first substructure and a the second substructure are molded to one another to define a continuous section of the composite structure having the reinforcement fibers in both the first pattern and the second pattern.

14. The composite structure of claim 13, wherein the first pattern comprises an arrangement of axial fibers disposed within the thermoplastic material of the first substrate.

15. The composite structure of claim 13, wherein:
the second pattern comprises an arrangement of axial fibers disposed within the thermoplastic material of the second substrate; and
the axial fibers of the second pattern are disposed off-axis to the axial fibers of the first pattern in the continuous section of the composite structure.

16. The composite structure of claim 13, wherein the first pattern comprises an arrangement of radial fibers disposed within the thermoplastic material of the first substrate.

17. The composite structure of claim 13, wherein:
the second pattern comprises an arrangement of radial fibers disposed within the thermoplastic material of the second substructure; and
the radial fibers of the second pattern are disposed off-axis to the radial fibers of the first pattern in the continuous section of the composite structure.

18. The composite structure of claim 13, wherein:
the first pattern comprises an arrangement of axial fibers disposed within the thermoplastic material of the first substrate; and
the second pattern comprises an arrangement radial fibers disposed within the thermoplastic material of the second substrate.

19. The composite structure of claim 13, wherein the reinforcement fibers of the first substructure and the reinforcement fibers of the second substructure are discontinuous with one another in the continuous section of the composite material.

20. The composite structure of claim 13, wherein at least one of the first substructure or the second substructure include reinforcement fibers in both the radial and the axial direction.

21. The composite structure of claim 13, wherein the continuous section defines a recycled composite structure.

22. The composite structure of claim 13, wherein the first pattern and the second pattern are arranged relative to one another in the continuous section to increase a stiffness of the composite structure.
